(19) United States
(12) Patent Application Publication
(10) Pub. No.: US 2016/0107922 A1
(43) Pub. Date: Apr. 21, 2016

(54) BUFFERING STRUCTURE AND CLAMPING DEVICE USING SAME

(71) Applicant: Shenzhen China Star Optoelectronics Technology Co., Ltd., Shenzhen, Guangdong (CN)

(72) Inventor: Kecheng XIE, Shenzhen, Guangdong (CN)

(21) Appl. No.: 14/370,288

(22) PCT Filed: Aug. 16, 2013
(86) PCT No.: PCT/CN13/81611

§ 371 Date: Jul. 2, 2014

(30) Foreign Application Priority Data
Jul. 11, 2013 (CN) 201310291380

(51) Int. Cl. C03B 33/033; B25B 5/16

(52) U.S. Cl. CPC C03B 33/033; B25B 5/163

(57) ABSTRACT

The present invention discloses a buffering structure includes at least two buffering layers connected with each other. The buffering layers are made of resilient material, and at least one of the buffering layers defines a number of hollow units therein.

### FIELD OF THE INVENTION

The invention relates to glass cutting technologies, and particularly, to a buffering structure contacting with a glass and a clamping device using the buffering structure.

### BACKGROUND OF THE INVENTION

A basic substrate is cut into a number of small pieces during a manufacture of a display panel. A clamp is usually used to break a cutting part from the basic substrate along a cutting line on the basic substrate. However, the basic substrate contacts with the basic substrate via a buffering structure which is a single layer structure and very hard. Thus, the buffering structure is easy to damage the basic substrate when the clamp is contacting with the basic substrate.

Therefore, it is desirable to provide a means which can solve the above-mentioned problems.

### SUMMARY OF THE INVENTION

To solve the above-mentioned problem, the present invention provides a buffering structure includes at least two buffering layers connected with each other. The buffering layers are made of resilient material, and at least one of the buffering layers defines a number of hollow units therein.

Wherein the hollow units are extended along a thickness direction of the buffering layers, and the hollow units are arranged as a matrix.

Wherein the hollow units in each of the buffering layers are arranged in a same form.

Wherein the hollow units in each of the buffering layers are arranged in different forms.

Wherein the shape of each hollow unit is selected from a group consisting of circular and rectangular.

Wherein the thickness of the buffering layer is selected from a range from 1 millimeter to 10 millimeter.

Wherein the different buffering layers are combined with each other by a plurality of bolts or an adhesive.

Wherein further includes an interlayer set between two buffering layers, the area of the interlayer is greater than the area of the buffering layer, and a part of the interlayer is protruded out from a periphery of the buffering layer when the interlayer is clamped between two buffering layers.

Wherein the interlayer is a solid made of resilient material.

A clamp device includes at least one clamp. Each clamp includes a pair of clamping arms rotatably connected with each other, a driver driving the clamping arms to rotate, and a buffering structure set on the clamping arms. Each of the clamping arms includes a connecting end and a clamping end opposite to the connecting end. The clamping arms are rotatably connected with each other at the connecting ends. The driver is set at a place where the clamping arms are connected and drives the clamping arms to rotate relative to each other. The buffering structure is set on a side surface of each clamping end facing the clamping end. The buffering structure includes at least two buffering layers connecting with each other. The buffering layers are made of resilient material, and one of the buffering layers defines a plurality of hollow units therein.

Wherein the hollow units are extended along a thickness direction of the buffering layers, and the hollow units are arranged as a matrix.

Wherein the hollow units in each of the buffering layers are arranged in a same form.

Wherein the hollow units in each of the buffering layers are arranged in different forms.

Wherein the shape of each hollow unit is selected from a group consisting of circular and rectangular.

Wherein the thickness of the buffering layer is selected from a range from 1 millimeter to 10 millimeter.

Wherein the different buffering layers are combined with each other by a plurality of bolts or an adhesive.

Wherein further includes an interlayer set between two buffering layers, the area of the interlayer is greater than the area of the buffering layer, and a part of the interlayer is protruded out from a periphery of the buffering layer when the interlayer is clamped between two buffering layers.

Wherein the interlayer is a solid made of resilient material.

A buffering structure includes more than two buffering layers connected with each other. The buffering layers are made of resilient material, and at least one of the buffering layers defines a plurality of hollow units therein along a thickness direction, and the hollow units are arranged at a matrix.

Wherein the buffering structure further includes an interlayer set between two buffering layers, wherein the area of the interlayer is greater than the area of the buffering layer, and a part of the interlayer is protruded out from a periphery of the buffering layer when the interlayer is clamped between two buffering layers.

The buffering structure and the clamping device using same employs a number buffering layers to buffer an interactive force between the cutting part and the clamping arms when the clamps clamp the cutting part. Thus, the damage to the cutting part made by the clamping arms is reduced.

### BRIEF DESCRIPTION OF THE DRAWINGS

In order to illustrate technical schemes of the present invention or the prior art more clearly, the following section briefly introduces drawings used to describe the embodiments and prior art. Obviously, the drawing in the following descriptions just is some embodiments of the present invention. The ordinary person in the related art can acquire the other drawings according to these drawings without offering creative effort.

FIG. 1 is a schematic structural view of a buffering structure and a clamping device using the buffering structure in accordance with a first embodiment of the present invention;

FIG. 2 is a schematic side view of the clamping device of FIG. 1;

FIG. 3 is a schematic structural view of the buffering structure of FIG. 1;

FIG. 4 is a schematic structural view of a number of hollow units of buffering structure of FIG. 1; and

FIG. 5 is a schematic structural view of a buffering structure and a clamping device using the buffering structure in accordance with a second embodiment of the present invention.

### DETAILED DESCRIPTION OF PREFERRED EMBODIMENTS

The following sections offer a clear, complete description of the present invention in combination with the embodiments and accompanying drawings. Obviously, the embodiments described herein are only a part of, but not all of the embodiments of the present invention. In view of the embodiments described herein, any other embodiment obtained by the person skilled in the field without offering creative effort is included in a scope claimed by the present invention.

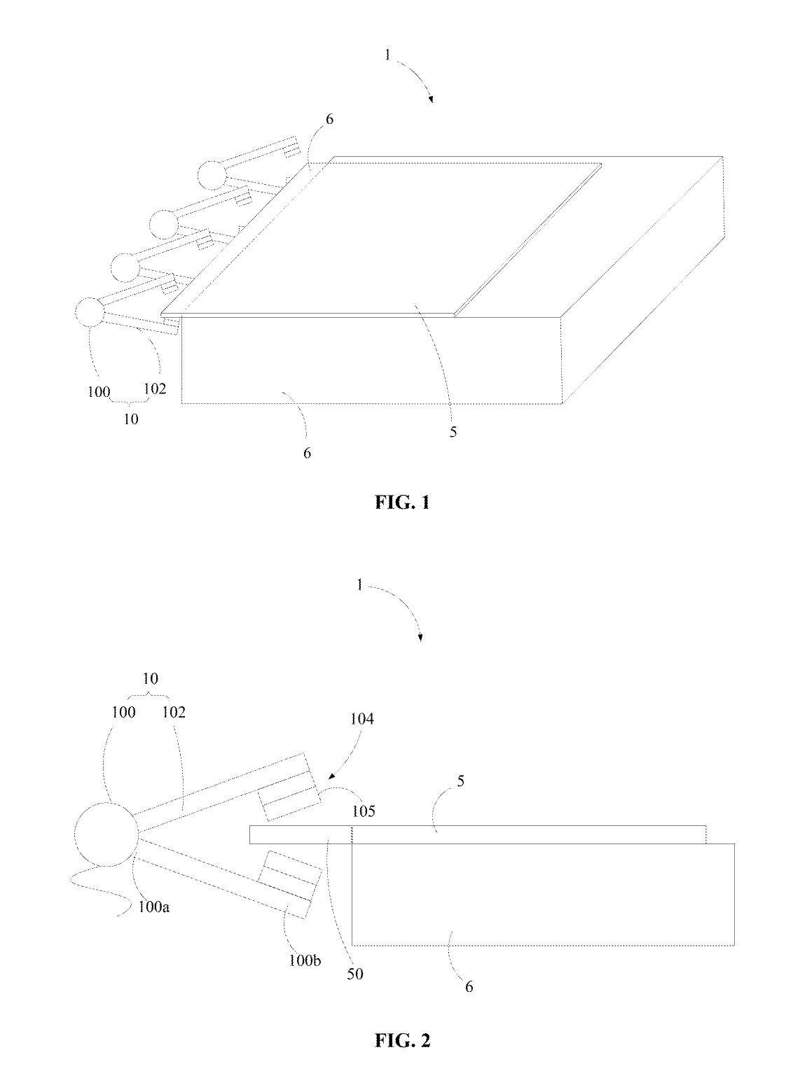

Referring to FIG. 1, a clamp device 1 provided by a first embodiment of this invention includes at least one clamp 10. Each clamp 10 includes a pair of clamping arms 100 and a driver 102. Each of the clamping arms 100 includes a connecting end 100a and a clamping end 100b opposite to the connecting end 100a. The clamping arms 100 are rotatably connected with each other at the connecting ends 100a. The driver 102 is set at a place where the clamping arms 100 are connected and drives the clamping arms to rotate relative to each other. There is a buffering structure 104 set on a side surface of each clamping end 100b facing the clamping end 100b of the other clamping arm 100. The buffering structure 104 includes at least two buffering layers connecting with each other. One of the buffering layers defines a number of hollow units 106 therein. The clamping ends 100b clamp a cutting part 50 of a glass substrate 5 via the buffering structure 104 to break the cutting part 50 from the glass substrate 5.

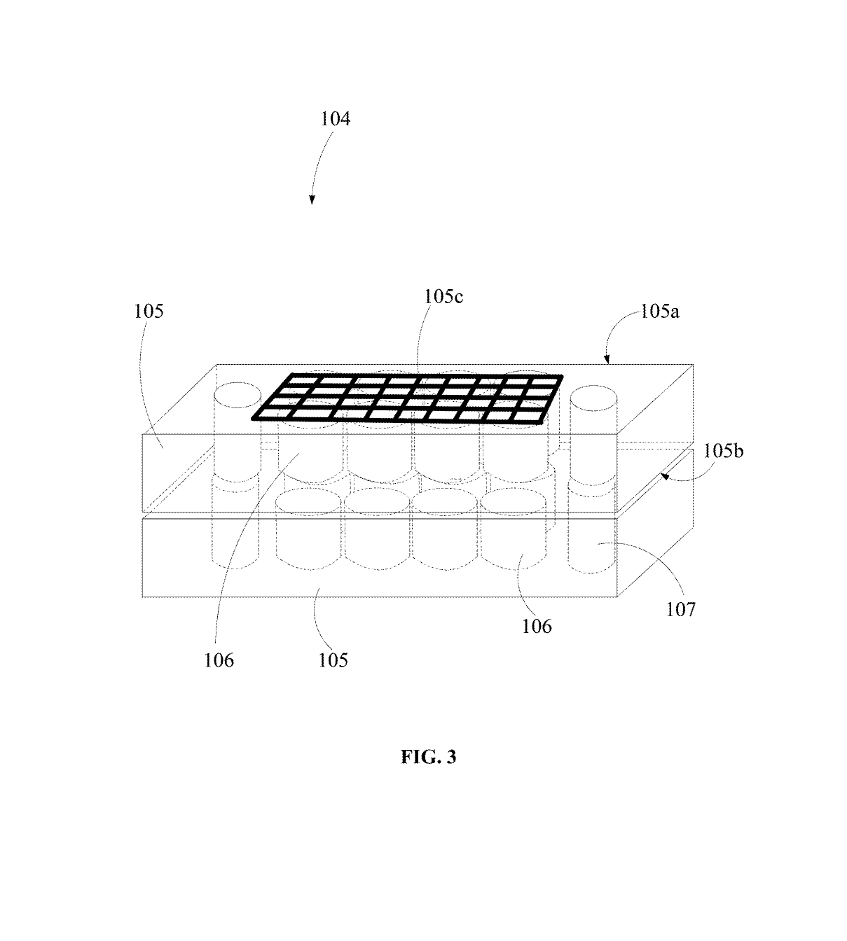

Referring to FIG. 3, each of the buffering layers 105 includes a first surface 105a and a second surface 105b parallel arranged along a thickness direction of buffering layer 105. The hollow units 106 extend along the thickness direction of the buffering layer 105. The hollow units 106 may be, but are not limited to circular or rectangular. The hollow units 106 are arranged as a matrix. The hollow units 106 in the different buffering layers 105 may be arranged in a same form or in different forms. The buffering layer 105 is made of a resilient material, such as plastic or resin. The different buffering layers 105 may be made of the same material or the different material. The thickness of the buffering layer 105 is selected from a range from 1 millimeter to 10 millimeter. Each of the buffering layers 105 defines a number of fastening through holes 107 passing through the first surface 105a and the second surface 105b. The different buffering layers 105 are combined with each other as the buffering structure by a number of bolts (not shown) screwing in the fastening through hole 107 or an adhesive.

Each clamping arm 100 of the same clamp 10 includes a clamping surface 100c facing each other. The buffering structure 104 is fastened on the clamping surface 100c near the clamping end 100b. A concave-convex pattern is formed on an outer surface of the outmost buffering layer 105 to increase a friction between the cutting part 50 and the buffering layer 105. In use, the cutting part 50 is protruded out from a periphery of a holder 6. The clamps 10 of the clamping device 1 are parallel arranged along a longitudinal direction of the cutting part 50. The clamping arms 100 are driven to move towards each other by the driver 102 in order to clamp the cutting part 50. The hollow units 106 buffer an interactive force between the cutting part 50 and the clamping arms 100 when the clamps 10 clamp the cutting part 50. Thus, the damage to the cutting part 50 made by the clamping arms 100 is reduced

In this embodiment, the hollow unit 106 is a cylindrical through hole extending inwards from the second surface 105b and passes through to the first surface 105a. The hollow units 106 are arranged as two parallel lines. There are four hollow units in each line. The buffering structure 104 includes two overlapping buffering layers 105. The hollow units 106 in the two buffering layers 105 are aligned with each other. The two buffering layers are connected with each other by the bolt passing through the fastening through hole 107.

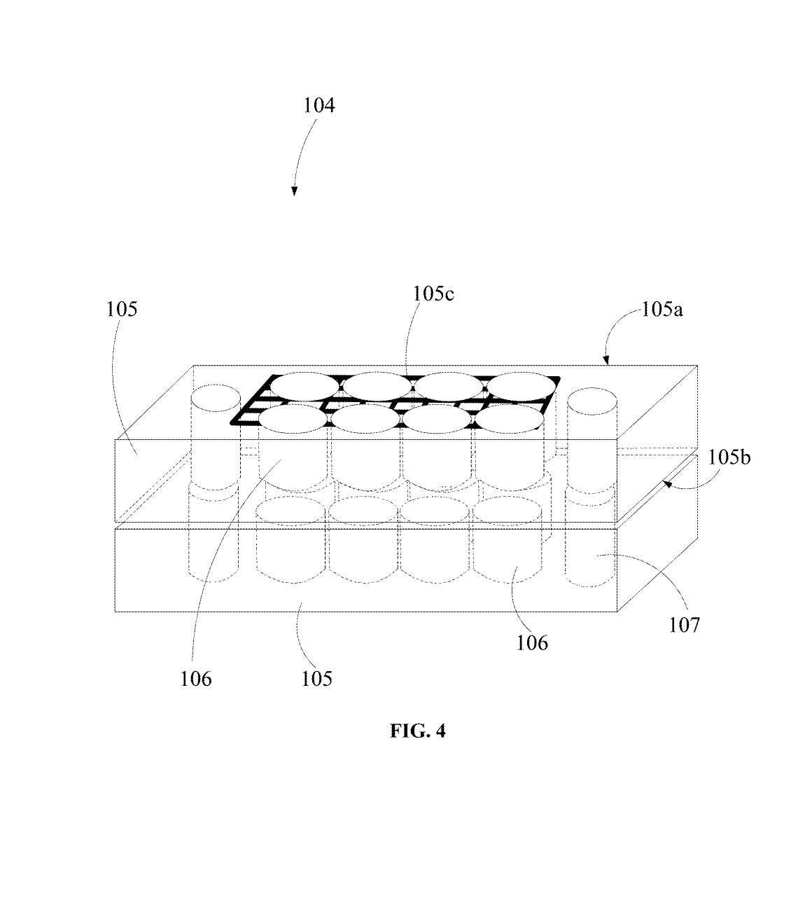

Referring to FIG. 4, in the other embodiment, the hollow units 106 are extended from the second surface 105b to the first surface 105a.

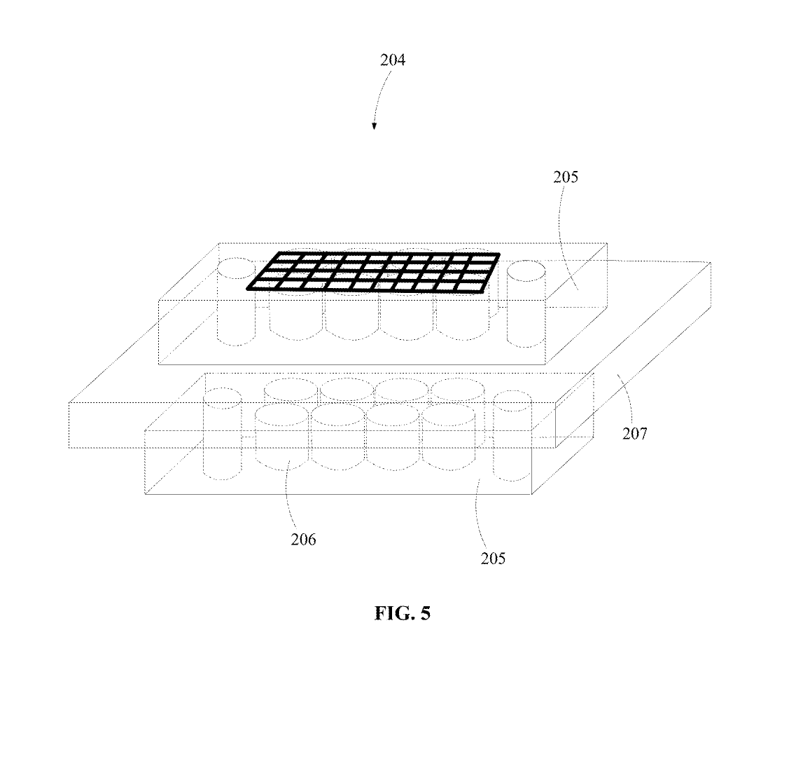

Referring to FIG. 5, the buffering structure 204 provided by a second embodiment of this invention is similar to the buffering structure 104 of the first embodiment, and the difference lie at the buffering structure 204 includes at least one interlayer 207 set between two buffering layers 205. The interlayer 207 is made of a resilient material. The interlay may be solid or includes the hollow units 206 set therein. The area of the interlayer 207 is greater than the area of the buffering layer 205. The interlayer 207 and the buffering layers 205 set two opposite sides of the interlayer 207 are fastened together by the bolts or adhesive. A part of the interlayer 207 is protruded out of a periphery from the buffering layer 205 when the interlayer 207 is clamped between two buffering layers 205. In use, the interlayer 207 is pressed to extend outwards by the buffering layers 205. Thus, the force applied to the buffering layers 205 is better buffered, the stress uniformity of the buffering structure 204 is improved, and damage to the glass substrate 5 is reduced.

What is said above are only preferred examples of present invention, not intended to limit the present invention, any modifications, equivalent substitutions and improvements etc. made within the spirit and principle of the present invention, should be included in the protection range of the present invention.

What is claimed is:

1. A buffering structure set at a place of a clamping device contacting with a body, the buffering structure comprising:
at least two buffering layers connected with each other;
wherein the buffering layers are made of resilient material, and at least one of the buffering layers defines a plurality of hollow units therein.

2. The buffering structure of claim 1, wherein the hollow units are extended along a thickness direction of the buffering layers, and the hollow units are arranged as a matrix.

3. The buffering structure of claim 2, wherein the hollow units in each of the buffering layers are arranged in a same form.

4. The buffering structure of claim 2, wherein the hollow units in each of the buffering layers are arranged in different forms.

5. The buffering structure of claim 1, wherein the shape of each hollow unit is selected from a group consisting of circular and rectangular.

6. The buffering structure of claim 1, wherein the thickness of the buffering layer is selected from a range from 1 millimeter to 10 millimeter.

7. The buffering structure of claim 1, wherein the different buffering layers are combined with each other by a plurality of bolts or an adhesive.

8. The buffering structure of claim 1, further comprising an interlayer set between two buffering layers, wherein the area of the interlayer is greater than the area of the buffering layer, and a part of the interlayer is protruded out from a periphery of the buffering layer when the interlayer is clamped between two buffering layers.

9. The buffering structure of claim 8, wherein the interlayer is a solid made of resilient material.

10. A clamp device comprising:
at least one clamp, each clamp comprising:
a pair of clamping arms rotatably connected with each other;
a driver driving the clamping arms to rotate; and
a buffering structure set on the clamping arms;
wherein each of the clamping arms comprises a connecting end and a clamping end opposite to the connecting end, the clamping arms are rotatably connected with each other at the connecting ends, the driver is set at a place where the clamping arms are connected and drives the clamping arms to rotate relative to each other, the buffering structure is set on a side surface of each clamping end facing the clamping end, the buffering structure comprises at least two buffering layers connecting with each other, the buffering layers are made of resilient material, and one of the buffering layers defines a plurality of hollow units therein.

11. The clamp device of claim 10, wherein the hollow units are extended along a thickness direction of the buffering layers, and the hollow units are arranged as a matrix.

12. The clamp device of claim 11, wherein the hollow units in each of the buffering layers are arranged in a same form.

13. The clamp device of claim 11, wherein the hollow units in each of the buffering layers are arranged in different forms.

14. The clamp device of claim 10, wherein the shape of each hollow unit is selected from a group consisting of circular and rectangular.

15. The clamp device of claim 10, wherein the thickness of the buffering layer is selected from a range from 1 millimeter to 10 millimeter.

16. The clamp device of claim 10, wherein the different buffering layers are combined with each other by a plurality of bolts or an adhesive.

17. The clamp device of claim 10, further comprising an interlayer set between two buffering layers, wherein the area of the interlayer is greater than the area of the buffering layer, and a part of the interlayer is protruded out from a periphery of the buffering layer when the interlayer is clamped between two buffering layers.

18. The clamp device of claim 17, wherein the interlayer is a solid made of resilient material.

19. A buffering structure comprising:
more than two buffering layers connected with each other;
wherein the buffering layers are made of resilient material, and at least one of the buffering layers defines a plurality of hollow units therein along a thickness direction, and the hollow units are arranged at a matrix.

20. The buffering structure of claim 19, further comprising an interlayer set between two buffering layers, wherein the area of the interlayer is greater than the area of the buffering layer, and a part of the interlayer is protruded out from a periphery of the buffering layer when the interlayer is clamped between two buffering layers.
